(19) United States
(12) Patent Application Publication
(10) Pub. No.: US 2009/0200408 A1
(43) Pub. Date: Aug. 13, 2009

(54) Automated Cheese Shredder For Applying Cheese To Pizza

(75) Inventor: Cathryn Fritz-Jung, Grosse Pointe Farms, MI (US)

Correspondence Address: HARNESS, DICKEY & PIERCE, P.L.C., P.O. BOX 828, BLOOMFIELD HILLS, MI, 48303, US

(73) Assignee: LITTLE CAESAR ENTERPRISES, INC., Detroit, MI (US)

(21) Appl. No.: 12/191,004

(22) Filed: Aug. 13, 2008

Related U.S. Application Data
(60) Provisional application No. 60/956,508, filed on Aug. 17, 2007.

(51) Int. Cl. A47J 43/25

(52) U.S. Cl. 241/92; 241/273.2

(57) ABSTRACT

An automatic cheese shredding and blending device, particularly for applying shredded cheese to pizza. The device can simultaneously shred blocks of multiple types of cheeses, and evenly apply a substantially homogenous blend of a chosen ratio of cheeses to a pizza or other food item. The device requires minimal operator interface. A motor creates relative rotational motion between the cheese blocks and one or more of grating elements to shred the cheese. A controller with a user-friendly operator interface is programmable to operate the device according to a desired use. The device includes an integrated refrigeration unit to keep the cheese fresh. Components are easily removable for cleaning and maintenance.

### CROSS-REFERENCE TO RELATED APPLICATIONS

This application claims the benefit of U.S. Provisional Application No. 60/956,508, filed on Aug. 17, 2007, which is incorporated herein by reference.

### FIELD

The present disclosure relates to a cheese shredder, and more particularly, to an automated cheese shredder that simultaneously shreds and applies a homogeneous blend of cheeses evenly over the top of a pizza.

### BACKGROUND

The statements in this section merely provide background information related to the present disclosure and may not constitute prior art.

In the pizza industry, the shredded cheese topping can be one of the most expensive components of the pizza. Particularly in the modern market, where the prices of dairy products in general are on the rise, members of the food industries are struggling to continue to offer their customers the same products for the same low prices.

Cheese suppliers charge a significant premium to grate, package, and ship shredded cheese. It is also more expensive and burdensome for restaurants to store bags of shredded cheese than it is to store blocks of cheese. However, procuring block cheese and shredding it before applying it to a pizza is undesirable, as it is extremely labor intensive, less efficient, and just as expensive as purchasing pre-shredded cheese, if not more so. Shredding and mixing a blend of cheeses to achieve a substantially homogeneous mixture of a desired ratio is even more labor intensive and inefficient. Pizza businesses are best suited to concentrate their efforts on their core competency, making better pizza, when preparing the ingredients demands minimal time and effort.

### SUMMARY

The present disclosure provides a device that automates the cheese shredding and application process, providing an efficient and cost-effective solution to the problems described above. The device can hold multiple blocks of cheese on a grater disposed above a pizza that is ready to accept shredded cheese. The cheese blocks may all be the same type of cheese, or there may be multiple types, to create a blend of cheeses. A motor and driveshaft create relative motion between the cheese blocks and a grater, simultaneously shredding and applying the cheese evenly onto a pizza below. An operator selects the desired amount of shredded cheese to be dispensed by inputting the corresponding number of motor revolutions into a user-friendly controller interface. A whole number of complete motor revolutions ensures a substantially homogenous blend of shredded cheeses will be applied to the pizza. A refrigeration unit incorporated into the device maintains the freshness of the cheese blocks over the course of a business day.

The device is easily disassembled, so the components can be quickly removed for cleaning and maintenance. The components that contact the cheese or the pizza can be easily cleaned by hand or in a dishwashing machine.

Although a minimal amount of operator interface is required, a number of safety features could be incorporated into the device to prevent operator injury.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a front view of an automated cheese shredder, according to the principles of the present disclosure;

FIG. 1a is a detail view of the grating elements shown in FIG. 1;

FIG. 2 is a partial section view of an automated cheese shredder taken along section line 2-2 shown in FIG. 1;

FIG. 3 is a top view of the grater, housing, and the positioning of the pizza pan and posts;

FIG. 4 is a side view of components shown in FIG. 3;

FIG. 5 is a top view of the cheese holder, the support members and the housing;

FIG. 6 is a section view of the components shown in FIG. 5 taken along section line 6-6;

FIG. 7 is a front view of an automated cheese shredder according to an alternative embodiment of the present disclosure;

FIG. 8 is a perspective view of the housing shown in FIG. 7;

FIG. 9 is a perspective view of the automated cheese shredder shown in FIG. 7 including the door, handle, and latching mechanism;

FIG. 10 is a plan view of a cheese holder according to an alternative embodiment of the present disclosure;

FIG. 11 is a plan view of yet another embodiment of the cheese holder according to the principles of the present disclosure;

FIG. 12 is a plan view of still another embodiment of the cheese holder according to the principles of the present disclosure;

FIG. 13 is a plan view of a cheese holder according to still another embodiment of the present disclosure;

FIG. 14 is a cross-sectional view of a spring mechanism for biasing the pressure plate;

FIG. 15 is a plan view of a cheese spreader according to the principles of the present disclosure;

FIG. 16a is a cross-sectional view of a grater and a funnel mechanism in a first position;

FIG. 16b is a cross-sectional view of a grater and a funnel mechanism in a second position; and

FIG. 16c is a cross-sectional view of a grater and a funnel mechanism in a third position.

### DETAILED DESCRIPTION

The following description is merely exemplary in nature and is not intended to limit the present disclosure, application, or uses. It should be understood that throughout the drawings, corresponding reference numerals indicate like or corresponding parts and features.

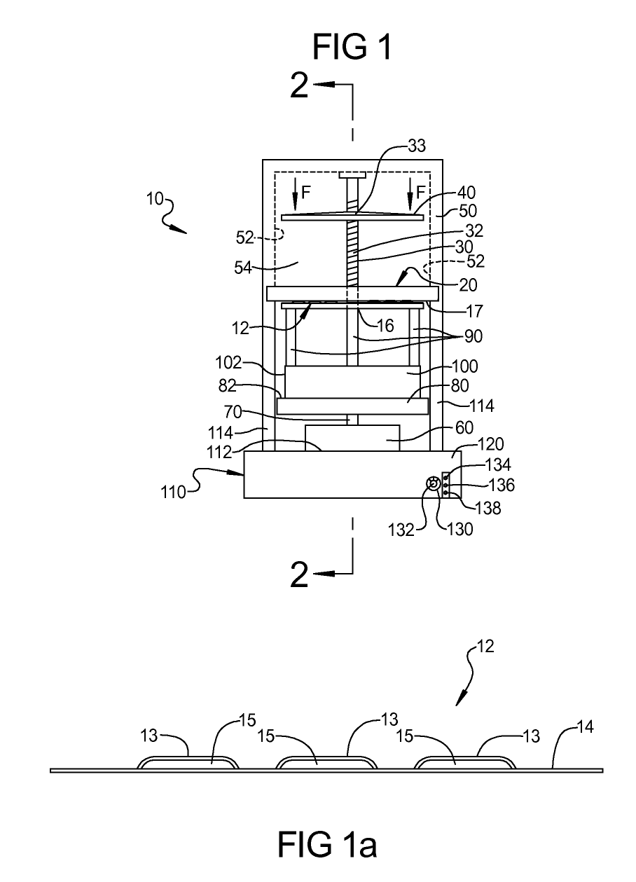

Referring now to FIG. 1, an automated cheese shredder for applying cheese to a pizza is shown, and is generally referred to as automated cheese shredder 10. A plurality of cheese blocks (not shown) can be placed on top of grater 12, inside cheese holder 20. A plurality of grating elements 13 are disposed over the top surface 14 of grater 12, as best shown in FIG. 1a. Grating elements 13 include shredding edges 15, that cut cheese shavings from the cheese blocks as grater 12 rotates about its center 16, relative to the cheese blocks.

Cheese holder 20 includes dividers 22, shown in FIG. 5, that form a plurality of chambers 24 that position the cheese blocks radially around the center 16 of the grater 12. It is possible to create a blend of shredded cheese by inserting blocks of different types of cheeses into the chambers 24. In the embodiment shown in FIG. 5, the three chambers 24 can be filled with two blocks of one type of cheese, and one block of another to create a 2:1 blend of two cheeses. Alternatively, the three chambers 24 can be filled with three different cheeses, to create a 1:1:1 blend of three cheeses. A 1:1 blend can be created when only two of the chambers 24 are filled with different types of cheeses; or if a single type of shredded cheese is desired, one, two, or three of the chambers 24 can be filled with a single type of cheese block.

A threaded rod 30 having external thread 32 is appropriately fastened to the grater 12, and extends upwardly through the center hole 26 of the cheese holder 20. A pressure plate 40 includes an internal thread 33 that is threadably engaged with threaded rod 30. The pressure plate 40 travels down the threaded rod 30 via threads 32, 33. The threads 32, 33 are sufficiently oriented and pitched so that one complete rotation will cause the pressure plate 40 to travel down threaded rod 30 a distance approximately equal to the amount of cheese that the grater 12 will shred from the cheese block during one rotation. The pressure plate 40 applies a continuous downward force F on the cheese blocks, providing sufficient pressure between the cheese blocks and the grater 12, enabling the grating elements 13 to efficiently cut cheese from the cheese blocks.

A refrigeration enclosure 50 can be removably fixed to cheese holder 20, and surrounds threaded rod 30, pressure plate 40 and the cheese blocks. The refrigeration enclosure 50 keeps the cheese blocks at an appropriate temperature to prevent them from spoiling. Refrigeration enclosure 50 can be removed from cheese holder 20 for cleaning, or to enable an operator to load new cheese blocks. The refrigeration enclosure can include refrigeration coils connected to a refrigeration system or, alternatively, can receive ice inserted therein.

The inner walls 52 of refrigeration enclosure 50 interfere with rotational movement of pressure plate 40. In the present embodiment, the pressure plate 40 and the cavity 54, formed by the inner walls 52 of refrigeration enclosure 50, are roughly rectangular prisms. The clearance between pressure plate 40 and inner walls 52 is appropriate to allow pressure plate 40 to travel downwardly, while preventing rotation. It should be appreciated that the pressure plate 40 and the cavity 54 can be shapes other than rectangular prisms, and one may employ other appropriate means to rotationally constrain pressure plate 40.

A motor 60 includes a driveshaft 70, which rotationally drives a turntable 80. Posts 90 are fixed to the top face 82 of the turntable 80 and to the bottom face 17 of the grater 12 to cause rotation of the grater 12 along with the turntable. A pizza pan 100 is removably disposed on the top face 82 of the turntable 80. The pizza pan 100 is properly positioned below the cheese blocks and grater 12 when its periphery 102 is in contact with at least two of the posts 90, shown best in FIGS. 3 and 4. The pizza pan 100 may contain a pizza (not shown) that is prepared to accept shredded cheese.

It should be noted that applying cheese to pizza is merely an example of a possible application of the current invention. It should be appreciated that the pan 100 may contain any food item to which shredded cheese may be applied. The term “pan,” as it is used in this specification, refers to any container suitable for containing a food item or for collecting shredded cheese, and does not necessarily need to be a container that is suitable for pizza preparation. It will also be appreciated that the pan 100 need not contain anything at all. An operator may simply choose to utilize pan 100 for collecting shredded cheese for some purpose that may or may not be related to pizza preparation.

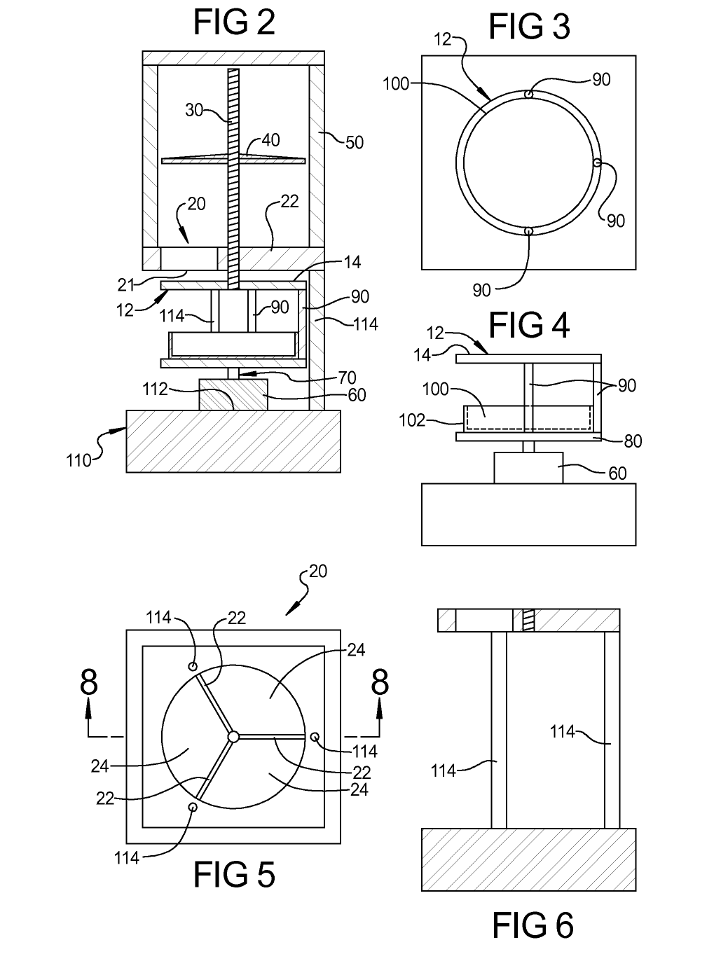

A housing 110 includes a motor mounting interface 112. The motor 60 can be mechanically connected to the motor mounting interface 112. Support members 114 can be appropriately fixed to the housing 110. Cheese holder 20 can be removably mounted to support members 114, fixing cheese holder 20 above the grater 12 (see FIGS. 1 and 2).

A controller 120, disposed within the housing 110, is electrically connected to the motor 60. The controller 120 can be programmed to cause the motor 60 to rotate the driveshaft 70 a whole number of 360 degree rotations or any other desired rotational amount. A whole number of 360 degree rotations causes a substantially homogenous mixture of the desired ratio of cheeses to be applied to the pizza.

A selection dial 130 can be in electrical communication with controller 120, and can include a plurality of settings 132 available for an operator to select. The settings 132 can indicate the amount of shredded cheese to be dispensed, and could correspond to the amounts of shredded cheese needed for large, medium and small pizzas, and other menu items made with shredded cheese.

Once the operator loads the cheese blocks into cheese holder 20 and moves selection dial 130 to a desired setting 132, actuation of an “On” button 134 will allow controller 120 to cause motor 60 to operate, causing the automated cheese shredder 10 to operate until the selected rotations are complete, or until an operator actuates an “Off” button 136.

After continued operation of automated cheese shredder 10, pressure plate 40 will eventually reach the end of its travel along threaded rod 30, before it contacts the grater 12. The controller 120 could be adapted to recognize this condition via sensors or switches (not shown) in communication with controller 120. An operator can then press a “Reset” button 138, which will cause the motor 60 to drive turntable 80, and therefore threaded rod 30, in the opposite direction until pressure plate 40 travels upwardly along threads 32 to the starting point at the top of threaded rod 30. At this time, an operator may load new cheese blocks into cheese holder 20. These new cheese blocks may be loaded directly on top of the remainders of the previous cheese blocks, so that they may be completely shredded.

A funnel mechanism 140 may be mounted to the grater 12 as shown in FIGS. 16a-16c. The funnel mechanism 140 includes an opening 142, through which shredded cheese passes upon being cut from the cheese blocks. The funnel mechanism 140 may be adjustable, so as to vary the diameter of opening 142. The inner walls 144 of the funnel mechanism 140 direct falling shredded cheese into pan 100, within a desired area. The inner walls can be defined by a two or more movable segments defining a generally cone shaped shutter-type structure, the inner diameter of which can be adjusted by pushing inward or pulling outward on the segments. The segments can be overlapped with a control segment or interconnected or connected by a pantograph or other linkage such that pushing one segment radially inward or outward will cause the other segments to move similarly. As yet another alternative, a draw string-type device can be used to interconnect the segments or a flexible annular material, and to draw them radially inwards and outwards to reduce and enlarge the opening 142. For square or rectangular pizzas of different sizes, the wall segments can be straight.

FIGS. 16a-16c illustrate an exemplary adjustment range of the funnel mechanism 140. The diameters shown in FIGS. 16a, 16b, and 16c may correspond to the diameters of small, medium, and large pizzas, respectively. Alternatively, funnels having different diameters can be provided and manually inserted by the user for each size of pizza being made.

The funnel mechanism 140 may be configured to allow an operator to manually actuate a mechanical linkage 146 to adjust the diameter of opening 142. Alternatively, the funnel mechanism 140 may be configured for electrical communication with controller 120, so as to allow electrical actuation of linkage 146. Settings 132 of selection dial 130 may be operable to allow an operator to select a desired diameter of opening 142.

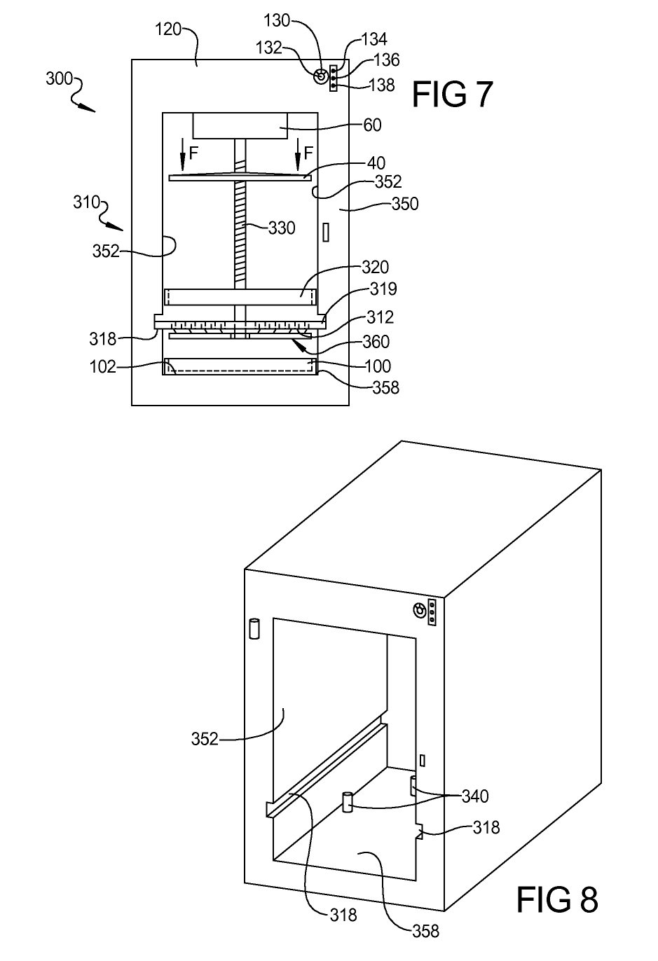

With reference to FIG. 7-9, wherein common reference numerals are used to represent common elements as disclosed in FIGS. 1-6, an alternative embodiment is shown. Automated cheese shredder 300 has a housing 310 containing controller 120 and refrigeration enclosure 350. In this embodiment, refrigeration enclosure 350 encloses the pizza pan 100, grater 312, cheese holder 320, threaded rod 330, pressure plate 40, motor 60, and motor housing 360. It should be appreciated that a similar type of refrigeration enclosure may be incorporated into the embodiment shown in FIGS. 1-6.

Refrigeration enclosure 350 includes a door 355, a handle 356, and a latching mechanism 357, shown in FIG. 9. Door 355 allows an operator easy access for loading and unloading pizza pans 100, loading new cheese blocks, and disassembling various components of automated cheese shredder 300 for cleaning.

Threaded rod 330 is appropriately connected to motor 60 and rotationally drives cheese holder 320. Cheese holder 320 includes dividers 22 and openings 24, which contain the cheese blocks and force them to rotate with cheese holder 320. Inner walls 352 prevent pressure plate 40 from rotating with threaded rod 330, so pressure plate 40 will travel downwardly and apply a force F to the tops of the cheese blocks, similar to the previously discussed embodiment.

Grater 312 is fixed below cheese holder 320. Grater 312 is constrained in two dimensions by slots 318, and constrained in the third dimension by door 355 when it is in a fully closed position and latching mechanism 357 is fully engaged. In this embodiment, the shredding work is accomplished by rotating the cheese holder 320 and the cheese blocks relative to a stationary grater 312. The funnel mechanism 140 may be mounted to grater 312, and may operate in a similar manner as previously described herein.

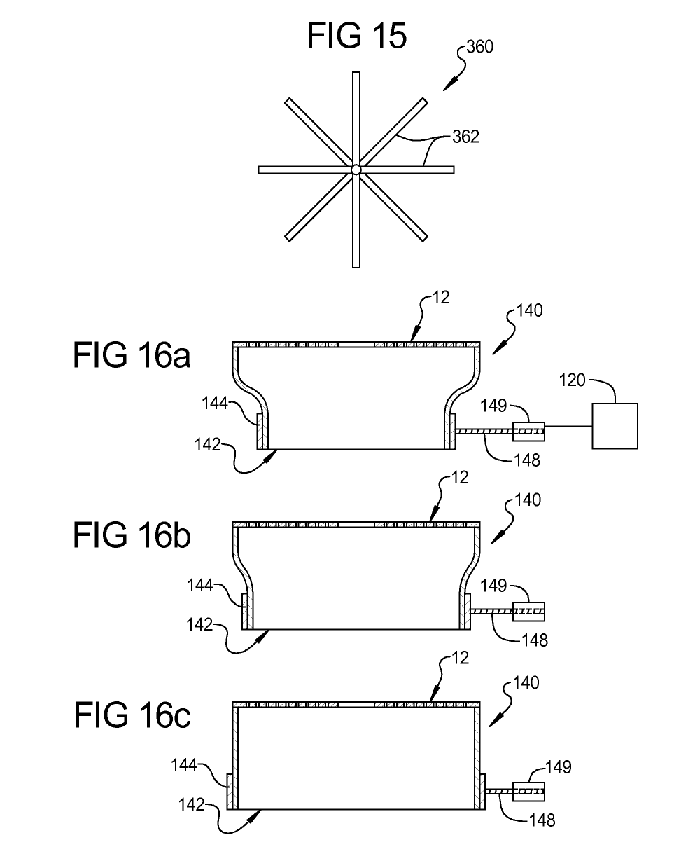

A cheese spreader 360 may be fixed to threaded rod 330, below grater 312, as shown in FIG. 7. Cheese spreader 360 includes a plurality of blades 362 (shown in FIG. 15) that spin as motor 60 rotates threaded rod 330. As shredded cheese falls from grater 312, spinning blades 362 are operable to break up clumps of shredded cheese, and to facilitate even mixture and distribution of the shredded cheese.

Pizza pan 100 is removably disposed on face 358 of the refrigeration enclosure 350. The pizza pan 100 is properly positioned below the cheese blocks and grater 312 when its periphery 102 is in contact with at least two posts 390, shown in FIG. 8.

The function of the controller 120 and the operator interface of automated cheese shredder 300 are substantially similar to that of the previously disclosed embodiment.

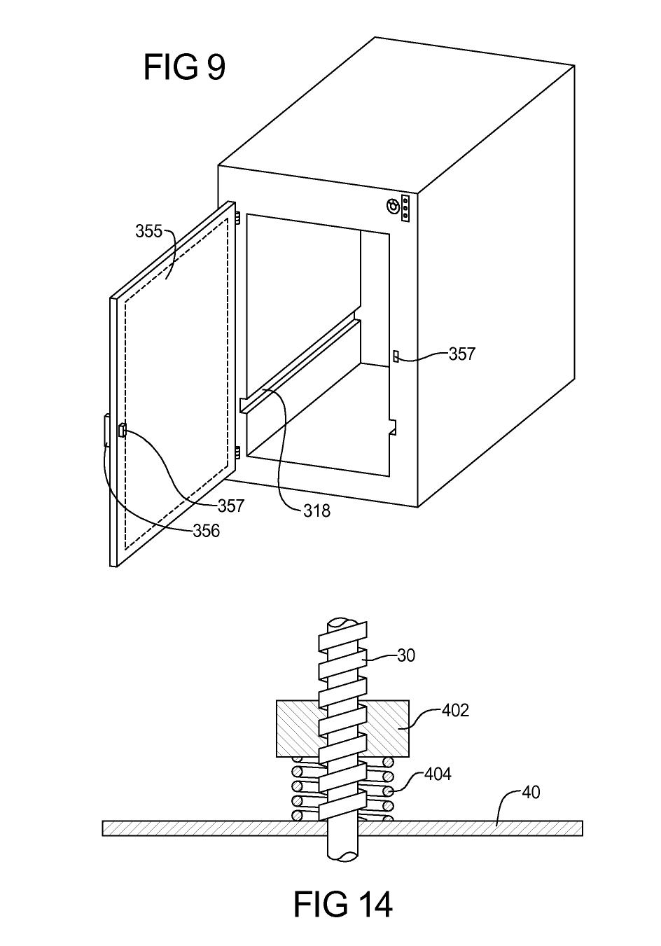

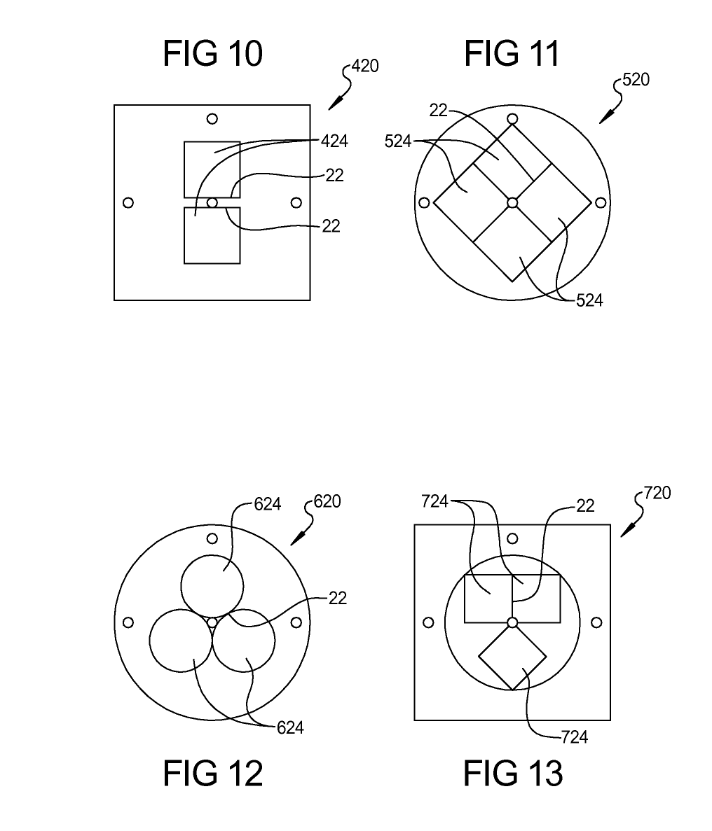

FIGS. 10-13 illustrate examples of alternative embodiments 420, 520, 620, 720 of cheese holder 20, 320. Dividers 22 can be configured in a variety of ways to form a variety of chambers 424, 524, 624, 724, respectively, depending on the shape of the cheese blocks and the number of cheese blocks that an operator chooses to simultaneously shred and blend.

The automated cheese shredder 10, 300 could include a number of emergency stop systems. For example, controller 120 could terminate power to motor 60 when a sensor (not shown) indicates that door 355 is open and latching mechanism 357 is not engaged. Alternatively, controller 120 could terminate power to motor 60 when a sensor (not shown) detects undue torque on motor 60, indicating an obstruction.

As shown in FIG. 14, a spring mechanism 400 can optionally be used to apply/absorb forces applied to the pressure plate against the cheese. The spring mechanism can include a threaded nut member 402 threadedly engaged with the screw rod 30. A coil spring 404 can be disposed axially between the nub member 402 and pressure plate 40 or alternatively, other spring mechanisms can be utilized. The spring can absorb pressure when the pressure plate 40 does not move consistently with the rotation of the threaded rod 30.

The components that may contact cheese or any other food item may be metallic, polymeric, ceramic, or any other material that is suitable for contact with food and regular cleaning. In a preferred embodiment, the grater 12, 312, cheese holder 20, 320, threaded rod 30, 330, pressure plate 40, and pizza pan 100 are easily disassembled from automated cheese shredder 10, 300, and are able to be cleaned by hand or in a dishwasher.

It should be appreciated that the features disclosed in any of the embodiments discussed in this specification may be combined and/or incorporated into any other embodiment discussed in this specification. The description of the invention is merely exemplary in nature; therefore, variations that do not depart from the gist of the invention are intended to be within the scope of the invention. Such variations are not to be regarded as a departure from the spirit and scope of the invention.

What is claimed is:

1. An automated cheese shredder comprising:
a cheese holder defining a chamber for holding at least one block of cheese;
a grater disposed adjacent to said cheese holder for grating cheese in said cheese holder;
a motor drivingly creating relative rotational motion between said grater and said cheese holder, said motor is drivingly connected to a threaded rod, threadably engaged with a pressure plate;
wherein said pressure plate is rotationally constrained and threadably traversable along said threaded rod to apply a downward force to said at least one block of cheese;
said relative rotational motion causing said grater to cut shreds of cheese from said at least one cheese block.

2. The automated cheese shredder according to claim 1, wherein said cheese holder is adapted to simultaneously contain a plurality of types of cheese blocks; and
said shreds of cheese cut from said plurality of types of cheese blocks are homogenously blended and deposited into a pizza pan.

3. The automated cheese shredder according to claim 1, wherein a refrigeration enclosure is disposed around said cheese holder and said cheese blocks.

4. The automated cheese shredder according to claim 3, wherein said refrigeration enclosure rotationally constrains said pressure plate.

5. The automated cheese shredder according to claim 1, wherein a controller is in electrical communication with said motor.

6. The automated cheese shredder according to claim 1, wherein said grater and said pizza pan are drivingly connected to said motor, and said cheese holder is fixed.

7. The automated cheese shredder according to claim 1, wherein said grater includes a plurality of grating elements arrayed over a surface of said grater.

8. The automated cheese shredder according to claim 1, wherein said cheese holder is drivingly connected to said motor, and said grater and pizza pan are fixed.

9. The automated cheese shredder according to claim 1, wherein said motor is mounted to a housing, said housing comprising said controller and said refrigeration unit.

10. An automated cheese shredder comprising:
a cheese holder including dividers for separately holding a plurality of types of cheese blocks;
a grater disposed adjacent to said cheese holder for grating said plurality of types of cheese blocks in said cheese holder;
a motor drivingly creating relative rotational motion between said grater and said cheese holder;
a compression device applying a compression force to said plurality of types of cheese blocks against said grater.
said relative rotational motion causing said grater to cut shreds of cheese from said plurality of types of cheese blocks, said shreds of cheese cut from said plurality of types of cheese blocks are homogenously blended and deposited onto a pizza pan.

11. The automated cheese shredder according to claim 10, wherein a refrigeration enclosure is disposed around said cheese holder and said plurality of types of cheese blocks.

12. The automated cheese shredder according to claim 10, wherein a controller is in electrical communication with said motor.

13. The automated cheese shredder according to claim 10, wherein said grater and said pizza pan are drivingly connected to said motor, and said cheese holder is fixed.

14. The automated cheese shredder according to claim 10, wherein said grater includes a plurality of grating elements arrayed over a surface of said grater.

15. The automated cheese shredder according to claim 10, wherein said cheese holder is drivingly connected to said motor, and said grater and pizza pan are fixed.

16. The automated cheese shredder according to claim 10, wherein said motor is mounted to a housing, said housing comprising said controller and said refrigeration unit.

17. An automated cheese shredder comprising:
a cheese holder for holding at least one block of cheese;
a grater disposed adjacent to said cheese holder for grating cheese in said cheese holder;
a motor drivingly creating relative rotational motion between said grater and said cheese holder;
a compression device applying a compression force to said at least one block of cheese;
said relative rotational motion causing said grater to cut shreds of cheese from said at least one cheese block;
an adjustable funnel device having an opening with an adjustable diameter for distributing cheese from said grater to different sized pizzas disposed below said grater.

18. The automated cheese shredder according to claim 17, wherein a refrigeration enclosure is disposed around said cheese holder and said at least one cheese block.

19. The automated cheese shredder according to claim 17, wherein a controller is in electrical communication with said motor.

20. The automated cheese shredder according to claim 17, wherein said grater is drivingly connected to said motor, and said cheese holder is fixed.

21. The automated cheese shredder according to claim 17, wherein said grater includes a plurality of grating elements arrayed over a surface of said grater.

22. The automated cheese shredder according to claim 17, wherein said cheese holder is drivingly connected to said motor, and said grater is fixed.

23. An automated cheese shredder comprising:
a cheese holder for holding at least one block of cheese;
a grater disposed adjacent to said cheese holder for grating cheese in said cheese holder;
a cheese spreader disposed below said grater and including a plurality of blades that break up cheese shreds below said grater;
a motor drivingly creating relative rotational motion between said grater and said cheese holder.

24. The automated cheese shredder according to claim 23, wherein said motor creates relative rotational motion between said cheese spreader and said grater.

25. The automated cheese shredder according to claim 23, further comprising a refrigeration enclosure disposed around said cheese holder.
